(19) United States
(12) Patent Application Publication
(10) Pub. No.: US 2026/0147013 A1
(43) Pub. Date: May 28, 2026

(54) SYSTEM AND METHOD FOR VISUAL ANEMOMETRY USING FLOW-STRUCTURE INTERACTIONS

(71) Applicant: California Institute of Technology, Pasadena, CA (US)

(72) Inventors: Roni Goldshmid, Pasadena, CA (US); John Oluseun Dabiri, Pasadena, CA (US); John E Sader, Pasadena, CA (US)

(21) Appl. No.: 19/397,285

(22) Filed: Nov. 21, 2025

Related U.S. Application Data
(60) Provisional application No. 63/724,598, filed on Nov. 25, 2024.
(60) Provisional application No. 63/779,595, filed on Mar. 28, 2025.

(51) Int. Cl. G01P 13/00; G01P 5/02; G06T 7/246; G06T 7/62; G06V 20/10

(52) U.S. Cl. CPC G01P 13/0013; G01P 5/02; G06T 7/251; G06T 7/62; G06V 20/188; G06T 2207/10016; G06T 2207/20081; G06T 2207/20084; G06T 2207/30188; G06T 2207/30192

(57) ABSTRACT

Systems and methods for determining wind speed are disclosed. The system includes a video capture device (e.g., a smartphone camera, a drone-mounted camera, or a satellite) to capture a video time-series of a pre-existing flexible object, such as natural vegetation, interacting with a wind flow. A processor is configured to analyze the video time-series to extract kinematic features of the object's motion and determine a quantitative wind speed. In one embodiment, a physics-informed neural network is used, which is trained to infer the object's mechanical properties (such as stiffness or species) from the video to solve for the wind speed. In another embodiment, a neural network is configured to receive a set of statistical feature maps, derived from the video's temporal signals, to determine the wind speed. In a further embodiment, the wind speed is determined by applying a first-principles physical formula based on the discovery that the fluctuating motion of individual leaves becomes decoupled from the branch structure at certain wind speeds, allowing for a quantitative measurement based on leaf size and measured leaf speed.

### CROSS REFERENCE TO RELATED APPLICATIONS

The present application claims priority to U.S. provisional patent application Ser. No. 63/724,598 entitled “Wind Speed and Direction Measurement Using Visual Images”, filed on Nov. 25, 2024, and to U.S. provisional patent application Ser. No. 63/779,595 entitled “Wind Speed and Direction Measurement Using Visual Images”, filed on Mar. 28, 2025, the disclosures of both of which are incorporated herein by reference in their entirety.

### STATEMENT OF GOVERNMENT GRANT

This invention was made with government support under Grant No. CBET2019712 awarded by the National Science Foundation. The government has certain rights in the invention.

### TECHNICAL FIELD

The present disclosure relates generally to optical elements and methods for designing and fabricating such elements. More specifically, it relates to computationally designed volumetric meta-optic structures for manipulating electromagnetic radiation, particularly for sorting light based on properties such as wavelength and polarization, and methods for their design and fabrication.

### BACKGROUND

Accurate and widespread measurements of wind speeds are beneficial for many engineering, commercial, and safety applications. For example, the wind energy sector requires detailed, spatiotemporally resolved wind maps to optimize turbine placement, detect damaging gusts, and predict economic returns. Airports require such maps to ensure safety during takeoff and landing, as strong shear winds can be hazardous. Improved weather and climate change models also depend on accurate wind data. Furthermore, knowledge of wind behavior can aid in mitigating the spread of wildfires and pollution and can enable optimal path-planning for package-delivery drones to reduce fuel consumption.

Current methods for measuring wind speed have significant limitations. Conventional anemometers, such as cup or ultrasonic anemometers, provide pointwise measurements. Obtaining a spatially resolved flow field with these instruments requires deploying a large number of them, which is often impractical due to high deployment costs and the intrusive nature of their installation.

Remote sensing technologies, such as Light Detection and Ranging (LIDAR), offer an alternative but are associated with high equipment costs, limited mobility, and constrained spatial resolution. LIDAR measurements also commonly rely on Taylor's Frozen Turbulence Hypothesis (TFTH), which can introduce measurement errors in the highly unsteady flows often present in the atmospheric surface layer. Other flow visualization techniques, like Particle Image Velocimetry (PIV) and Particle Tracking Velocimetry (PTV), are generally more suited for controlled laboratory experiments as they require artificial seeding of the flow, which is impractical for large-scale atmospheric measurements

Therefore, a need exists for a low-cost, non-intrusive, mobile, and scalable method for obtaining accurate, spatiotemporally resolved wind maps. The present disclosure addresses this need by leveraging pre-existing objects in the environment, such as vegetation, as natural sensors for visual anemometry

### SUMMARY

The present disclosure provides systems and methods for determining wind speed by analyzing video of flow-structure interactions. The general concept involves using a video capture device (such as a smartphone camera, a camera mounted on a drone or other vehicle, or a satellite) to record a video time-series of the wind-induced motion (kinematics) of pre-existing, flexible objects in the environment. These objects, particularly natural vegetation (e.g., trees, branches, leaves, or grass), act as ubiquitous, natural sensors. A computational model, executed by a processor, analyzes the video to extract features of this motion and translates those features into a quantitative wind speed measurement.

In a first embodiment, the present disclosure provides a system and method utilizing a physics-informed neural network (PI-NN). This approach addresses a non-uniqueness problem inherent in purely data-driven models, where the motion of a flexible object in light wind can appear similar to the motion of a stiff object in strong wind. The PI-NN of this embodiment solves this by being trained to simultaneously analyze the motion kinematics of the object and infer the object's physical and mechanical properties (e.g., species, size, stiffness) from the video itself. By combining the kinematic features with the inferred mechanical properties, the model can produce a more accurate and generalizable wind speed prediction.

In a second embodiment, the present disclosure provides a system and method utilizing a neural network that operates on statistical features. In this approach, the raw video time-series is first pre-processed by a signal generation module to create multiple “major signals” representing different temporal scales of motion (e.g., a moving average, residuals from that average, and finite differences of the residuals). A statistical feature module then calculates a set of statistical values (e.g., max, min, mean, RMS, skewness, kurtosis) for each of these signals over time, creating a stack of statistical feature maps. This stack of maps, which represents the motion in a condensed format, is then fed as input into a convolutional neural network (CNN) that performs a regression to output the predicted wind speed.

In a third embodiment, the present disclosure provides a system and method based on a first-principles physical model, which does not rely on machine learning. This method is based on the discovery that at low-to-moderate wind speeds (e.g., corresponding to a leaf-based wind Reynolds number between approximately 1,000 and 10,000), the fluctuating motion of individual leaves becomes decoupled from the supporting branch structure. This decoupling allows the leaves to be treated as independent “particles” whose motion is driven by local flow instabilities. This discovery enables the use of a direct physical formula:

$${U}_{wind} \approx \sqrt{\frac{μ {U}_{leaf}}{ρ D}}$$

where U_{wind} is the wind speed, U_{leaf} is the measured fluctuating speed of the leaf, D is the characteristic size of the leaf, μ and ρ are the known dynamic viscosity and mass density of the air. The wind speed is found by measuring D and U_{leaf} from the video (in pixels and pixels per second, respectively, and/or meters and meters per second, respectively) and applying the formula.

According to a first aspect of the present disclosure, a method for determining wind speed is disclosed, the method comprising: capturing, via a video capture device, a video time-series of a pre-existing vegetation target interacting with a wind flow; processing the video time-series, via a processor, to extract one or more kinematic features representing the motion of the vegetation target, and determining, via the processor, a quantitative wind speed of the wind flow based on the one or more extracted kinematic features.

According to a second aspect of the present disclosure, a system for determining wind speed is provided, the system comprising: a video capture device configured to capture a video time-series of vegetation interacting with a wind flow; a processor; and a non-transitory computer-readable medium operably connected to the processor, the medium storing instructions that, when executed by the processor, cause the system to perform a method comprising: processing the video time-series to extract one or more kinematic features representing the motion of the vegetation; and determining a quantitative wind speed of the wind flow based on the one or more extracted kinematic features.

### BRIEF DESCRIPTION OF THE FIGURES

FIG. 1 shows a schematic layout of the experimental setup including vegetation, an anemometer, and the mean wind direction.

FIG. 2A shows a schematic of a baseline, data-driven neural network architecture representing prior art.

FIG. 2B shows a schematic of the physics-informed coupled Convolutional and Recurrent Neural Network architecture according to an embodiment of the present disclosure.

FIG. 3 panels A-C show examples of cropped video frame inputs, including training, validation, and test sets of vegetation and flags.

FIG. 4 panels A-B show graphs of the mean Neural Network model predictions versus ground truth wind speeds for both validation and test sets.

FIG. 5 shows a flowchart of the statistical image processing procedure for extracting signal statistics (moving mean, residuals, finite differences) from video frames.

FIG. 6A shows a schematic of the neural network architecture according to an embodiment of the present disclosure, configured to process input statistics, showing feature extraction, normalization, and regression output layers.

FIG. 6B shows the corresponding training and validation plots for the architecture of FIG. 6A, graphing predicted wind speed versus ground truth wind speed.

FIG. 7A shows a graph plotting scattered raw data of leaf speed versus wind speed.

FIG. 7B shows a graph of the universal data collapse of the same data from FIG. 7A when non-dimensionalized.

FIG. 8 panels A-D show time series graphs and error histograms comparing visual anemometry predictions against ground truth sonic anemometer measurements for field validation.

FIG. 9 shows a system diagram illustrating an exemplary hardware implementation of the disclosed methods according to the teachings of the present disclosure.

### DETAILED DESCRIPTION

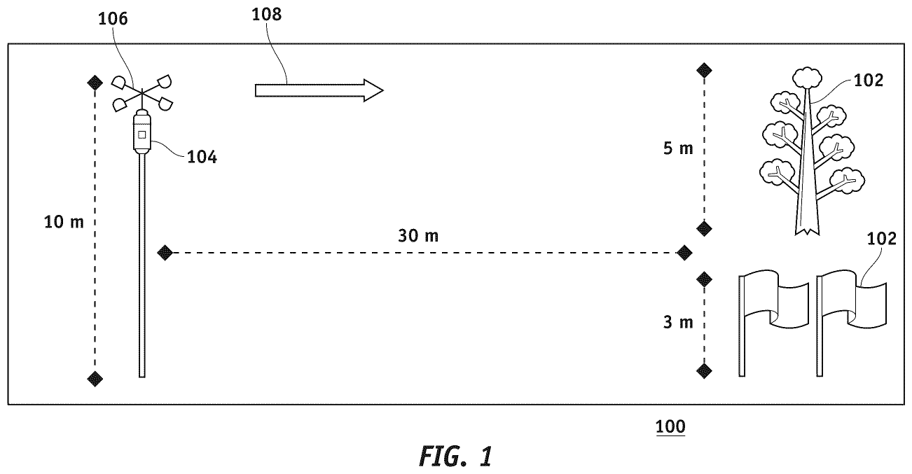

FIG. 1 shows a schematic layout of an experimental setup and system environment 100 for visual anemometry, illustrating the interaction between a target object 102 and the wind. The system 100 generally comprises an imaging device 104 positioned to capture a video time-series of the target object 102, such as natural vegetation (e.g., a tree) or an artificial structure (e.g., a flag). As illustrated, the setup includes a reference anemometer 106 (e.g., a sonic or cup anemometer) mounted at the specific height of the tree (e.g., 10 m) to provide ground truth wind speed and direction data for calibration or validation purposes. The target object 102, such as a tree, is located within the field of view of the imaging device 104. The distances between the imaging device 104, the reference anemometer 106, and the target object 102 are configured to ensure the visual field captures the relevant kinematic behavior of the object under the influence of the mean wind direction, indicated by arrow 108.

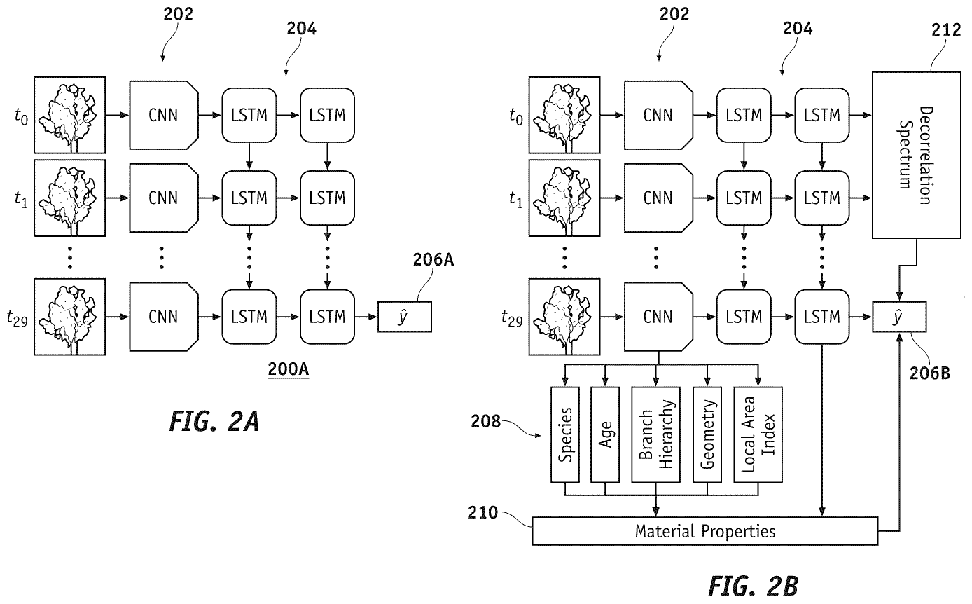

FIGS. 2A-2B show a schematic comparison contrasting a baseline data-driven model with the improved physics-informed neural network architecture according to the teachings of the present disclosure.

FIG. 2A shows a baseline, data-driven neural network architecture 200A, which represents the prior art. This architecture is designed to process a video time-series (frames t₀, . . . , t₂₉). In this model, each frame is fed into a Convolutional Neural Network (CNN) 202 to extract spatial features. The sequence of these extracted features is then fed into a Recurrent Neural Network (RNN) 204, such as a Long-Short Term Memory (LSTM) network, which analyzes the temporal behavior. The RNN 204 outputs a single regression value, the predicted wind speed 206A, represented by ŷ. While this model provides a proof-of-concept, it suffers from performance limitations and generalizability issues, particularly when faced with new objects not in the training set. This is due to a non-uniqueness problem, where the model cannot distinguish between visually similar kinematics, such as the motion of a highly flexible object in a light wind versus the motion of a stiff object in a strong wind.

FIG. 2B shows the physics-informed neural network architecture 200B in accordance with a first embodiment of the present disclosure. Such architecture is an improvement upon the baseline model shown in FIG. 2A. The architecture 200B is specifically designed to solve the non-uniqueness problem by supplementing the kinematic analysis with an explicit inference of the object's physical properties. This architecture includes a primary kinematics model, which, similar to what is shown in FIG. 2A, may use a CNN 202 and an RNN 204 to process the video time-series and extract motion features. However, the architecture 200B further comprises one or more parallel property-extraction neural networks 208. Such additional networks are trained to analyze the same video input to identify and extract a set of physical properties of the target object. As illustrated, these physical properties may include, but are not limited to, the object's species, age, branch hierarchy, geometry, and leaf area index. An inference module 210 then uses these extracted physical properties to deduce the object's mechanical properties, such as its stiffness.

Continuing with the embodiment of FIG. 2B, the architecture 200B may further include an analysis module 212 that computes a motion decorrelation spectrum from the kinematic features provided by the RNN 204. The motion features from the primary kinematics model, the inferred mechanical properties, and the motion decorrelation spectrum, are finally combined to determine a final, quantitative wind speed prediction 206B. By explicitly accounting for the object's physical and mechanical properties, this system can distinguish between the non-unique scenarios and produce a wind speed prediction that is accurate and generalizable to new, previously unseen vegetation, which is not possible with the prior art model.

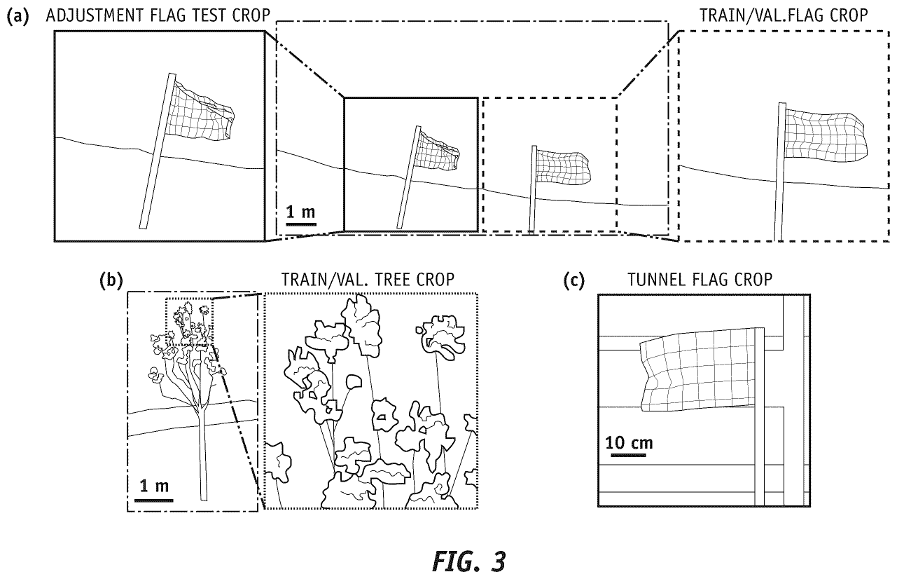

FIG. 3 shows examples of the cropped video frame inputs that are processed by the neural network architectures shown in FIGS. 2A-2B. This visual data represents the raw input (e.g., at frames t₀, . . . , t₂₉) that is fed into the CNN feature extractors 202 of FIG. 2A-2B for feature extraction. FIG. 3 is divided into three exemplary panels, (a), (b), and (c), showing different categories of this input data. Panel (a) of FIG. 3 shows the “Adjacent Flag Test Crop”. This is a set of video clips from a flag that was not used during the training or validation of the model. It serves as an unseen “test set” for the specific purpose of evaluating the final generalizability of the trained models. Panel (b) of FIG. 3 shows the “Train/Val. Tree Crop” which is a designation referring to Training and Validation data; this is the primary dataset used to train the model and subsequently check its performance (validate) during the development process. This data is used to build both the baseline model (FIG. 2A) and the improved physics-informed model (FIG. 2B). Panel (c) of FIG. 3 shows the “Tunnel Flag Crop”. This is a second, distinct “test set” used to assess model generalizability. This crop is from a different, scaled flag (smaller size) recorded in a controlled wind tunnel environment. Together, these panels illustrate the types of visual data the system ingests. The data from “Train/Val” crops (like ‘b’) is used to build the models, while the data from “Test” crops (like ‘a’ and ‘c’) is used to confirm the models' ability to function on new, unseen objects and environments. This testing is used to demonstrate the improved generalizability of the architecture in FIG. 2B over the prior art in FIG. 2A.

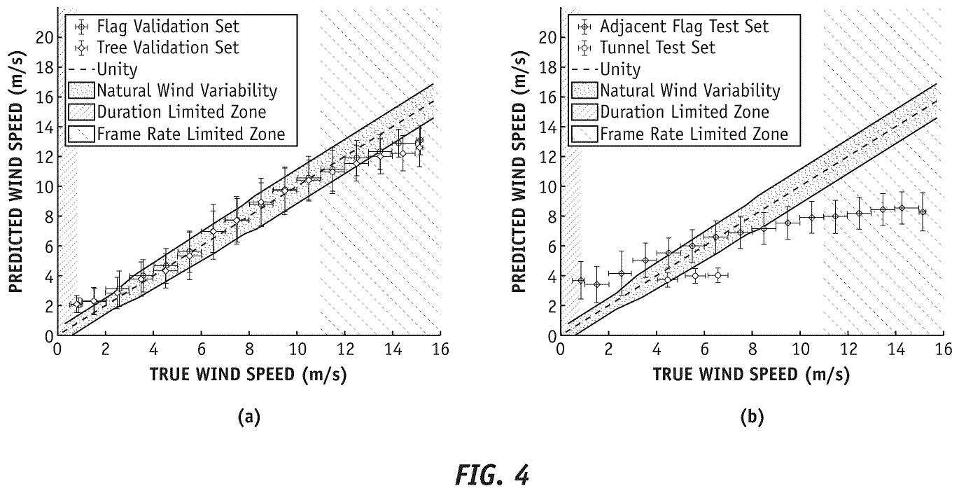

Following the description of the visual input data in FIG. 3, FIG. 4 presents the quantitative performance and validation results of the neural network model (shown in FIG. 2) when processing that data. The figure consists of two plots, (a) and (b), which graph the Predicted Wind Speed (y-axis) versus the True Wind Speed (x-axis), as measured by the ground truth anemometer.

Plot (a) of FIG. 4 illustrates the model's performance on the validation set, which corresponds to the “Train/Val” crops shown in FIG. 3. This plot includes data from the “Flag Validation Set” and the “Tree Validation Set”. The predictions for both object types align very closely with the “Unity” line (dashed black), which represents a perfect, one-to-one correlation. The predictions also fall largely within the “Natural Wind Variability” band, which represents the inherent uncertainty and turbulent fluctuations of the wind itself. This alignment demonstrates that the model is highly accurate and has successfully learned the relationship between object motion and wind speed for the validation data.

Plot (b) of FIG. 4 illustrates the model's generalizability by showing its performance on the unseen test sets, which correspond to the “Adjacent Flag Test Crop” and “Tunnel Flag Crop” described in FIG. 3. This plot shows the results for the “Adjacent Flag Test Set” and the “Tunnel Test Set”. The data demonstrates that the model, even when applied to new objects in new locations and at different scales, successfully captures the correct qualitative increasing trend. This result confirms the model's ability to generalize beyond the specific data it was trained on, which is the objective of the disclosed methods.

With continued reference to FIG. 4, In both plots (a) and (b), the shaded “Duration Limited Zone” and “Frame Rate Limited Zone” indicate the physical boundaries of the system. These regions represent wind speeds that are too low (limited by clip duration) or too high (limited by the camera's frame rate) to be accurately resolved by the input video, as defined by physics-based scaling arguments.

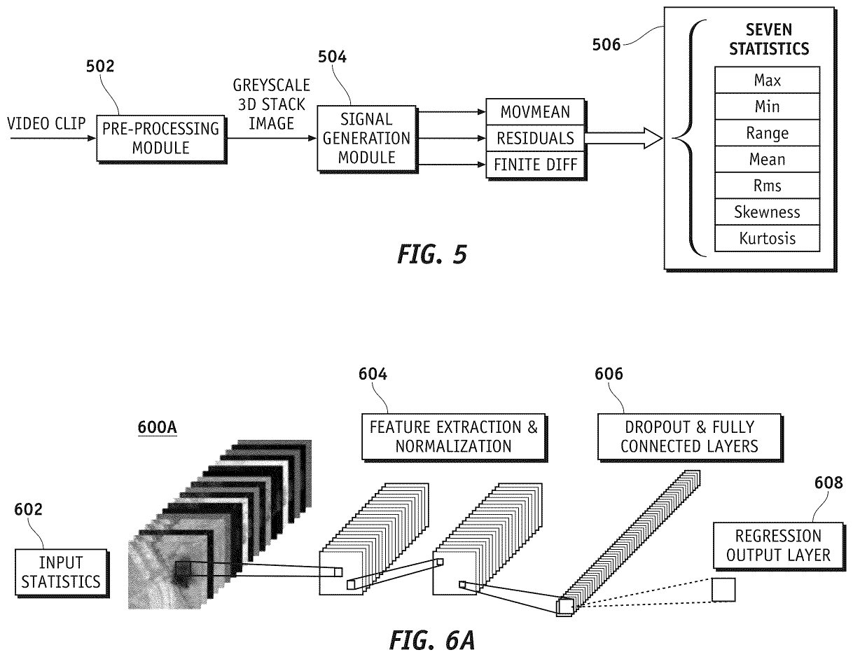

FIG. 5 provides an exemplary process flowchart 500 illustrating the data-processing pipeline for a second embodiment of the present disclosure. As described later, this second embodiment utilizes a neural network that operates on statistical features rather than raw video frames. The flowchart 500 details the pre-processing steps used to convert a video time-series into a compact statistical representation.

The process begins with the input video clip, which is first converted by a pre-processing module 502 into a greyscale time-series, represented as a 3D stack of images. A signal generation module 504 then processes this greyscale time-series to create “three major signals,” each representing different temporal characteristics of the object's motion:
“movmean”: A moving average of the signal is computed with respect to time, capturing the low-frequency motion.
“residuals”: This signal is generated by subtracting the “movmean” from the instantaneous greyscale signal, isolating the high-frequency motion.
“finite diff.”: A finite difference of the “residuals” signal is calculated, representing the rate of change of the high-frequency motion.
   Next, a statistical feature module 506 calculates a set of “seven statistics” for each of the three major signals. As illustrated, these statistics are: Maximum, Minimum, Range, Mean, Rms (Root-Mean-Square), Skewness, and Kurtosis. The output of this entire process is a stack of statistical feature maps (e.g., 3 signals×7 statistics=21 maps).

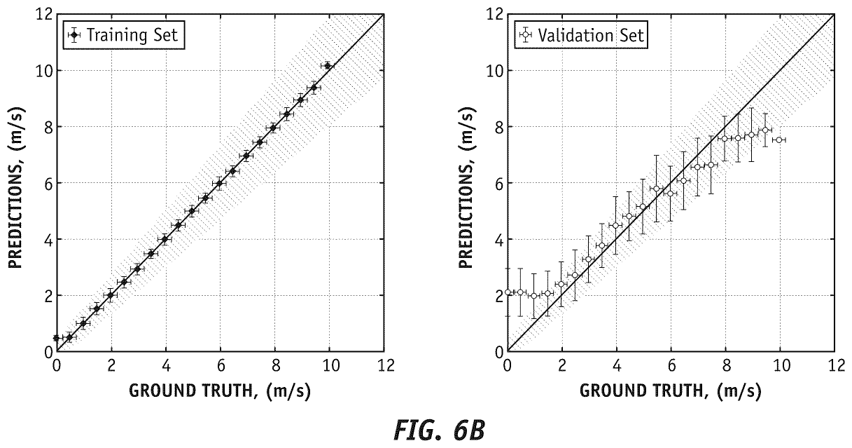

Instead of a raw video, the stack of condensed statistical information as described above can be used as input to a neural net word architecture. FIG. 6 shows an exemplary neural network architecture 600A according to the second embodiment of the present disclosure. This neural network architecture may be implemented to process the stack of statistical feature maps generated by the pipeline in FIG. 5. The process begins as the input statistics 602, which are the statistical maps derived in FIG. 5, are fed into the network 600A. These maps are first processed by the Feature extraction and normalization layers 604. The resulting features are then passed through Dropout and fully connected layers 606. Finally, a regression output layer 608 processes these features to determine the quantitative wind speed.

FIG. 6B also includes two validation plots for the statistical embodiment shown in FIG. 6A. The left plot shows the model's predictions versus the ground truth wind speed for the Training set. The right plot shows the same for the Validation set. In both plots, the data points fall on the one-to-one unity line, demonstrating the accuracy and predictive capability of this statistical approach.

A third embodiment of the present disclosure is directed to a system and method that determines wind speed using a first-principles physical model, based on a discovery of the underlying physics of leaf motion in wind. This embodiment does not rely on a machine learning model for inference.

According to the teachings of the present disclosure, at low-to-moderate wind speeds, the fluctuating motions of individual leaves can be decoupled from their supporting branch structure. This decoupling means that the leaves behave as natural “particles” that are held in position by the plant's support structure, and their motion can be analyzed to infer the impinging wind speed in a form of natural particle tracking velocimetry. This finding enables the development of a physics-based visual anemometry technique that does not rely on the specific structural properties of the plant, such as branch stiffness or size.

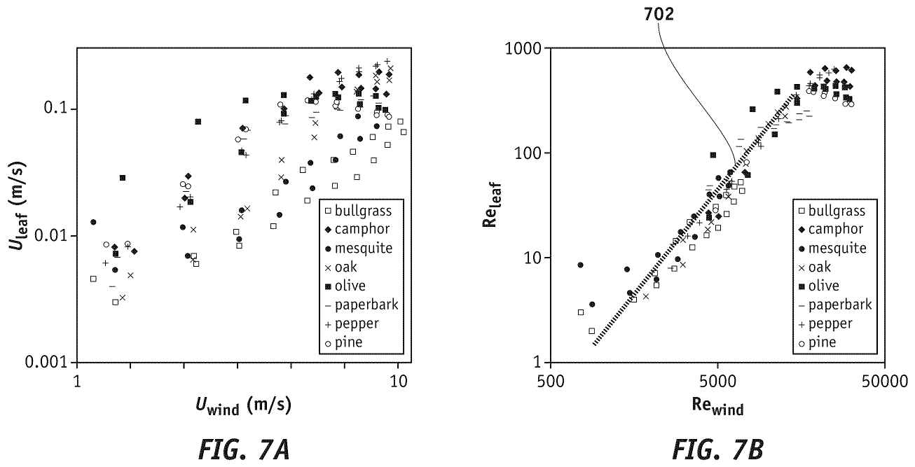

In order to further clarify this, reference is made to FIG. 7A showing the problem by plotting the raw measured data of the fluctuating leaf speed U_{leaf} versus the impinging wind speed U_{wind}. The data is shown for eight different vegetation species, including bullgrass, camphor, oak, olive, and pine. As shown, the data is widely scattered, and there is no apparent universal trend connecting the measured leaf speed to the wind speed across the different plant species.

According to the third embodiment of the present disclosure, this scattering is resolved using dimensional analysis. The relevant physical variables are identified as the fluctuating leaf speed U_{leaf}, the impinging wind speed U_{wind}, the characteristic size of the leaf D, the air mass density p, and the air viscosity u. These variables are used to establish two dimensionless groups, as shown in below:

$$A Leaf Reynolds number : {Re}_{leaf} = ρ {U}_{leaf} D / μ \qquad 1.$$

$$A Wind Reynolds number : {Re}_{wind} = ρ {U}_{wind} D / μ \qquad 2 .$$

As shown in FIG. 7B, when the scattered data from FIG. 7A is re-plotted using the two above-mentioned dimensionless groups, it produces a previously unforeseen collapse of the measured dataset. As shown in FIG. 7B, this universal data collapse is observed regardless of the plant species and their structural properties. According to the teachings of the present disclosure, this collapse shows that the observed leaf motion is due to local flow instabilities generated by the leaf itself. This universal data collapse, shown as the fitted line 702 in FIG. 7B, demonstrates a functional dependence. A least-squares fit of this dataset, within the valid range of 1000≤Re_{wind}≤10000, indicates an empirical form which is a quadratic power law described as:

$${Re}_{leaf} \approx {( {Re}_{wind} / C )}^{2}$$

where C is an empirical constant found to be C=740±30.
By rearranging this empirical form and using previously mentioned dimensionless groups, a direct dimensional formula for calculating the wind speed can be obtained as follows:

$${U}_{wind} \approx C \sqrt{\frac{μ {U}_{leaf}}{ρ D}}$$

This formula enables the quantitative wind speed U_{wind} to be measured from remote video observations of the fluctuating speed of the leaves U_{leaf}. The required inputs are the measured U_{leaf} and the characteristic leaf size D, along with the known constants for air viscosity u and density p.

The above-disclosed method is applicable at low-to-moderate wind speeds, corresponding to an impinging wind Reynolds number Re_{wind} in the range of approximately 1,000 to 10,000. At higher wind speeds Re_{wind}≥10000, the independent leaf hypothesis breaks down, and the plant motion becomes characterized by a “collective downstream sweeping” where branch stiffness and interactions play a dominant role.

According to the third embodiment of the present disclosure, the method for measuring the leaf speed U_{leaf} from the video includes the steps of:
1. Applying a “small control volume” (an aerial region in the video) in a “patchwork manner” across the plant to provide full canopy coverage.
2. Computing cross-correlation coefficients between successive video frames for each control volume.
3. Using these coefficients to yield the displacement vector for all leaves within each control volume, and thus the displacement field across the plant
4. Calculating the velocity field from this displacement field using the known frame rate of the camera (e.g., 60 Hz)
5. Averaging the magnitude of the velocity vector in each control volume across all control volumes to yield the final “leaf speed” U_{leaf} for the plant

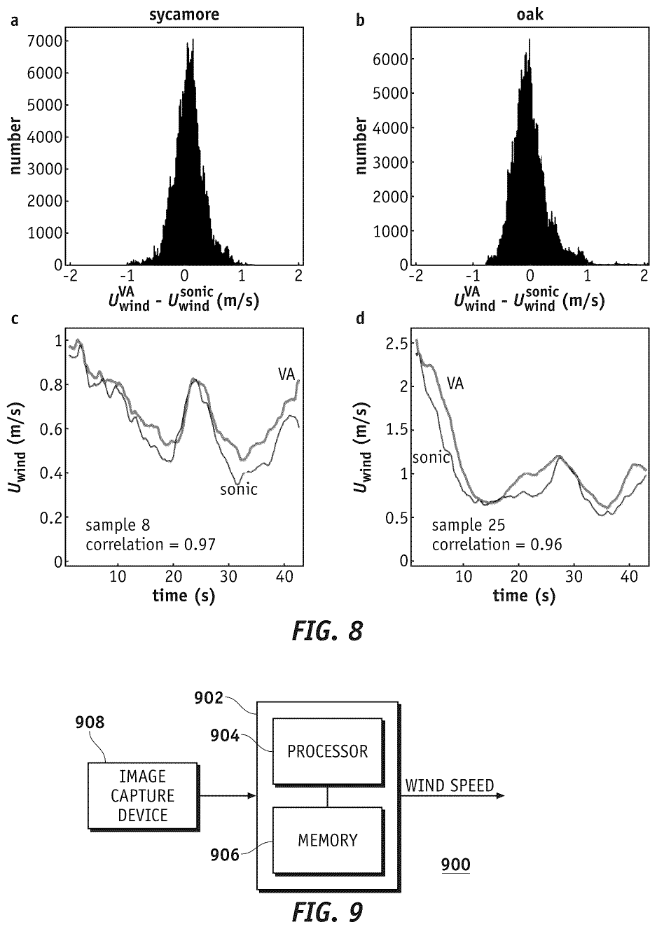

FIG. 8 provides the field validation data for the third embodiment by comparing its wind speed predictions against a “ground truth” measurement. The figure shows data obtained from remote observations of two different trees in a natural setting: a California sycamore and an Engelmann oak. A sonic anemometer was placed next to the trees to independently measure the local wind speed as a benchmark. The figure is divided into two types of plots:
Histograms (Panels a, b): These plots illustrate the distribution of the error, or the difference between the wind speed measured by the formula (“VA”) and the wind speed measured by the sonic anemometer (“sonic”). Both for the sycamore (a) and the oak (b), the histograms are tightly centered around zero. This indicates a very low bias and substantial quantitative agreement.
Time Series (Panels c-d): These plots compare the instantaneous wind speed measurements over time. The wind speed recovered from the formula (Eq. 2) is labeled “VA” (orange line), and the independent sonic anemometer measurement is labeled “sonic” (blue line). Panels (c) and (d) show examples with the cross-correlation (0.97 and 0.96, respectively), demonstrating that the disclosed method allows for an accurate tracks the wind's fluctuations.

Importantly, the U_{wind} predictive relation does not require explicit camera calibration because U_{leaf} and D appear in the ratio U_{leaf}/D, any constant pixel to length scale cancels, so both quantities may be obtained directly in pixels. With μ and ρ provided in SI units, the expression

$${U}_{wind} \approx C \sqrt{\frac{μ {U}_{leaf}}{ρ D}}$$

returns wind speed in meters per second without the need to estimate absolute vegetation dimensions.

The described methods and devices provide a low-cost and highly accessible method for wind measurement, overcoming the significant financial and logistical barriers of current technologies. The disclosed teachings may be implemented using inexpensive and ubiquitous imaging hardware, such as a smartphone camera, in place of expensive instruments like LIDAR, which can cost tens of thousands of dollars, or traditional anemometers, which require costly, intrusive installation. By leveraging pre-existing objects in the environment, such as the world's 3.04 trillion trees as natural sensors, the described methods are non-intrusive and highly scalable. This allows for the creation of detailed, spatiotemporally resolved wind maps over large areas, a task that is impractical with fixed-point anemometers.

The described methods are designed for mobility, enabling implementation on platforms such as unmanned aerial vehicles (drones) or even next-generation, high-resolution satellites. This mobility unlocks critical, on-demand wind mapping for a variety of applications. This includes mitigating the spread of wildfires and pollution, optimizing turbine placement and detecting damaging gusts in the wind energy sector, and improving safety at airports by mapping hazardous shear winds. Furthermore, it enables optimal, fuel-saving path-planning for drones and provides valuable data for improving weather models and controlling agricultural pesticide dispersal.

The third embodiments of the present disclosure involves a method that are universal across different types of vegetation because it relies on the newly discovered phenomenon of decoupled leaf motion. By treating individual leaves as independent particles, this embodiment's formula does not require calibration for specific plant mechanical properties, such as branch stiffness, species, or size, which is a significant limitation of all other structure-based approaches.

The embodiments described herein may be implemented as a concrete system and method tied to specific physical hardware. This is illustrated in FIG. 9. The system 900 of FIG. 9 comprises a signal processing unit 902 including at least one processor 904 and a non-transitory computer-readable medium 906 (memory) operably connected to the processor 904. The image capture 908 device, such as a digital camera, a smartphone camera, a camera mounted on an unmanned aerial vehicle (drone), or a satellite imaging system, comprises a physical sensor that captures light from the real-world environment. This captured visual data, representing the physical flow-structure interaction of the target object, is stored in the memory as a tangible video time-series.

The processor is configured to execute specific instructions, corresponding to the methods of the described embodiments, stored on the non-transitory medium. This execution constitutes a specific technological improvement to the field of fluid dynamics and meteorology, providing a low-cost, mobile, and non-intrusive solution to a technical problem inherent in prior art systems. The processor performs a tangible transformation of data: it transforms the raw pixel data from the video time-series, which represents the physical motion of vegetation, into a quantitative, numerical wind speed value. This output is not just an abstract number, but a useful, concrete, and tangible result that can be used to improve other technological processes, such as navigating a drone, optimizing wind turbine placement, or providing critical data for managing real-world physical events like wildfires

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A method for determining wind speed, the method comprising:
capturing, via a video capture device, a video time-series of a pre-existing vegetation target interacting with a wind flow;
processing the video time-series, via a processor, to extract one or more kinematic features representing the motion of the vegetation target, and
determining, via the processor, a quantitative wind speed of the wind flow based on the one or more extracted kinematic features.

2. The method of claim 1, wherein processing the video time-series and determining the wind speed are performed by a neural network model.

3. The method of claim 2, wherein the neural network model comprises a convolutional neural network (CNN) configured for feature extraction from frames of the video time-series, and a recurrent neural network (RNN) configured to analyze a temporal sequence of the extracted features.

4. The method of claim 2, further comprising:
processing the video time-series, via one or more parallel neural networks, to extract one or more physical properties of the vegetation target;
inferring, via the processor, one or more mechanical properties of the vegetation target from the extracted one or more physical properties, and
wherein determining the quantitative wind speed is further based on the inferred one or more mechanical properties.

5. The method of claim 4, wherein the one or more physical properties are selected from the group consisting of: species, age, branch hierarchy, leaf area index, and one or more geometric properties.

6. The method of claim 4, further comprising:
calculating a motion decorrelation spectrum from the one or more kinematic features, the spectrum quantifying a correlation between kinematics of different components of the vegetation target, and
wherein determining the quantitative wind speed is further based on the motion decorrelation spectrum.

7. The method of claim 2, wherein processing the video time-series comprises:
generating one or more signal time-series from the video time-series, and
calculating one or more statistical feature maps from the one or more signal time-series;
wherein the one or more kinematic features comprise the one or more statistical feature maps, and wherein the neural network model is configured to receive the one or more statistical feature maps as input.

8. The method of claim 7, wherein the one or more signal time-series are selected from the group consisting of: a moving average time-series, a residuals time-series, and a finite-difference time-series.

9. The method of claim 8, wherein the one or more statistical feature maps are calculated using a statistic selected from the group consisting of: maximum, minimum, range, mean, RMS, skewness, and kurtosis.

10. The method of claim 1, wherein the vegetation target comprises one or more leaves, and wherein the one or more kinematic features comprise a fluctuating speed U_{leaf} of the one or more leaves.

11. The method of claim 10, further comprising:
determining, from the video time-series, a characteristic size D of the one or more leaves;
wherein determining the quantitative wind speed is performed using a physical formula based on a ratio μU_{leaf}/ρD, where μ is a dynamic viscosity of air and ρ is a mass density of air.

12. The method of claim 11, wherein the quantitative wind speed U_{wind} is determined by the formula
$${U}_{wind} \approx C \sqrt{\frac{μ {U}_{leaf}}{ρ D}} ,$$
where C is an empirical constant.

13. The method of claim 12, wherein C is equal to 740.

14. The method of claim 11, wherein the method is performed when a wind Reynolds number Re_{wind}, based on the characteristic size D and the wind flow, is between 1,000 and 10,000.

15. The method of claim 1, wherein the video capture device is mounted on an unmanned aerial vehicle (drone) or a satellite.

16. A system for determining wind speed, comprising
a video capture device configured to capture a video time-series of vegetation interacting with a wind flow;
a processor; and
a non-transitory computer-readable medium operably connected to the processor, the medium storing instructions that, when executed by the processor, cause the system to perform a method comprising:
processing the video time-series to extract one or more kinematic features representing the motion of the vegetation; and
determining a quantitative wind speed of the wind flow based on the one or more extracted kinematic features.

17. The system of claim 16, wherein the instructions further cause the system to:
process the video time-series via one or more parallel neural networks to extract one or more physical properties of the vegetation;
infer one or more mechanical properties of the vegetation from the extracted physical properties; and
determine the quantitative wind speed based on the one or more kinematic features and the inferred one or more mechanical properties.

18. The system of claim 16, wherein the instructions to process the video time-series comprise instructions to:
generate one or more signal time-series from the video time-series, the one or more signal time-series selected from the group consisting of: a moving average time-series, a residuals time-series, and a finite-difference time-series, and
calculate one or more statistical feature maps from the one or more signal time-series; and wherein the one or more kinematic features comprise the one or more statistical feature maps.

19. The system of claim 16, wherein the vegetation comprises one or more leaves, and the instructions further cause the system to:
determine a characteristic size D of the one or more leaves from the video time-series;
extract a fluctuating speed U_{leaf} of the one or more leaves as the one or more kinematic features; and
determine the quantitative wind speed U_{wind} by applying a formula
$${U}_{wind} \approx C \sqrt{\frac{μ {U}_{leaf}}{ρ D}} ,$$
where μ is a dynamic viscosity of air, ρ is a mass density of air, and C is an empirical constant.

20. The system of claim 19, wherein the instructions are executed when a wind Reynolds number based on the characteristic size D is between approximately 1,000 and 10,000.

21. The system of claim 19, wherein the fluctuating speed U_{leaf} is measured in pixels/second and the characteristic size D is measured in pixels.

22. The system of claim 19, wherein the fluctuating speed U_{leaf} is measured in meters/second and the characteristic size D is measured in meters.
